(19) United States
(12) Patent Application Publication
(10) Pub. No.: US 2005/0264537 A1
(43) Pub. Date: Dec. 1, 2005

(54) Electronic device

(75) Inventor: Chun Fei Yang, Teipei (TW)

Correspondence Address: QUINTERO LAW OFFICE, 1617 BROADWAY, 3RD FLOOR, SANTA MONICA, CA, 90404, US

(73) Assignee: WISTRON CORPORATION, TAIPEI HSIEN (TW)

(21) Appl. No.: 10/929,261

(22) Filed: Aug. 30, 2004

(30) Foreign Application Priority Data
May 31, 2004 (TW) TW93208538

(51) Int. Cl. G09G 5/00

(52) U.S. Cl. 345/173

(57) ABSTRACT

An electronic device. The electronic device includes a housing and a touchpad module disposed in the housing. The touchpad module includes a body, a light permeable element, and a light source. The body has a surface. The light permeable element is disposed adjacent to the surface. The light source is disposed near the body, emitting a light passing through the light permeable element.

### BACKGROUND

The invention relates to an electronic device and more particularly to an electronic device with a touchpad module disposed therein.

FIG. 1 shows a conventional notebook computer. The notebook computer 1 comprises a housing 11 comprising an opening 111 formed therein. A self-illuminating touchpad module 12 is disposed in the opening 111. The surface of the touchpad module 12 is utilized to control a cursor on a monitor 14. However, the arrangement of the touchpad module 12 spoils the appearance of the housing 11 as a whole. Further, a conventional self-illuminating touchpad module is more expensive than a conventional touchpad module, thus increasing costs.

### SUMMARY

Embodiments of an electronic device comprise a housing and a touchpad module disposed therein. The touchpad module comprises a body, a light permeable element, and a light source. The body comprises a surface. The light permeable element is disposed adjacent the surface. The light source is disposed near the body, emitting a light passing through the light permeable element.

### BRIEF DESCRIPTION OF THE DRAWINGS

Embodiments of the invention can be more fully understood by reading the subsequent detailed description in conjunction with the examples and references made to the accompanying drawings, wherein:

FIG. 1 is a perspective view of a conventional notebook computer;

FIG. 2 is a cross-sectional view of a touchpad module of an embodiment of the invention;

FIG. 3 is a perspective view of an electronic device of an embodiment of the invention;

FIG. 4A is a cross-sectional view of inner structure of an electronic device of a first embodiment of the invention; and

FIG. 4B is a cross-sectional view of inner structure of an electronic device of a second embodiment of the invention.

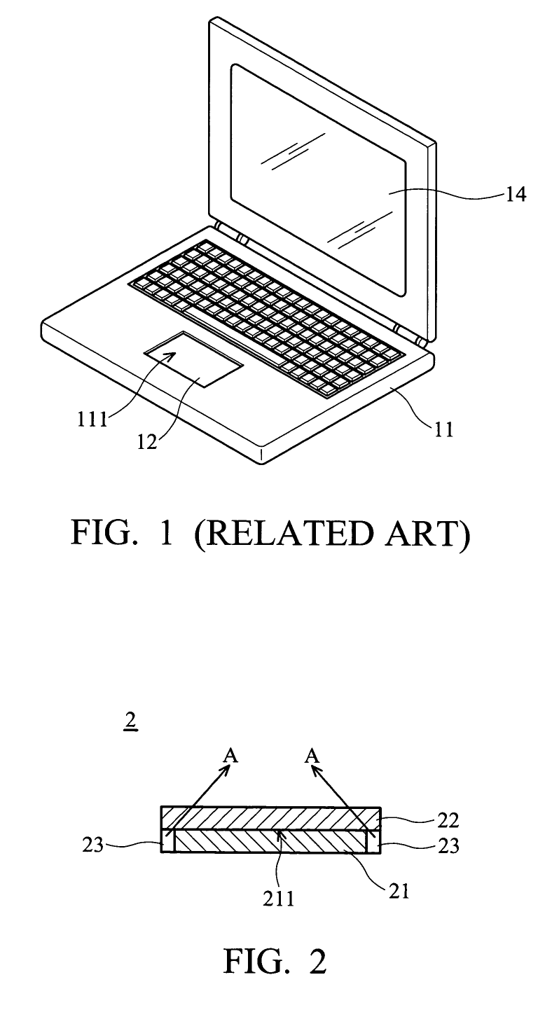

### DETAILED DESCRIPTION

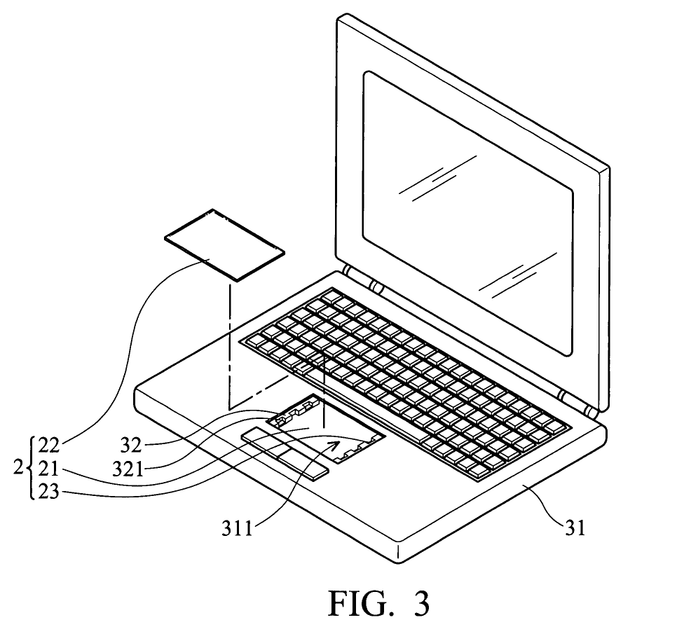

In FIG. 2, a touchpad module 2 with light emitting function comprises a body 21, a light permeable element 22, and a light source 23. The body 21 has a surface 211, with the light permeable element 22 disposed on and contacting the surface 211. The light source 23 is disposed adjacent to the body 21, and emits a light A passing through the light permeable element 22.

In embodiments of the invention, the light permeable element 22 may be Polycarbonate (PC), Mylar, or a sheet made of translucent material or transparent material. Moreover, the light permeable element 22 may have a pattern formed thereon. The light source 23 may be a light emitting diode (LED). The colors and number of the light source 23 can vary according to requirements.

FIG. 3 shows an electronic device with the touchpad module. In an embodiment of the invention, the electronic device may be a notebook computer, a personal digital assistant (PDA), a portable communication device, or the like. In this embodiment, the electronic device is a notebook computer.

The electronic device 3 comprises a housing 31 and a light emitting touchpad module 2 disposed thereon. Thus, the area of the housing 31 where the touchpad module 2 is mounted can emit light.

### First Embodiment

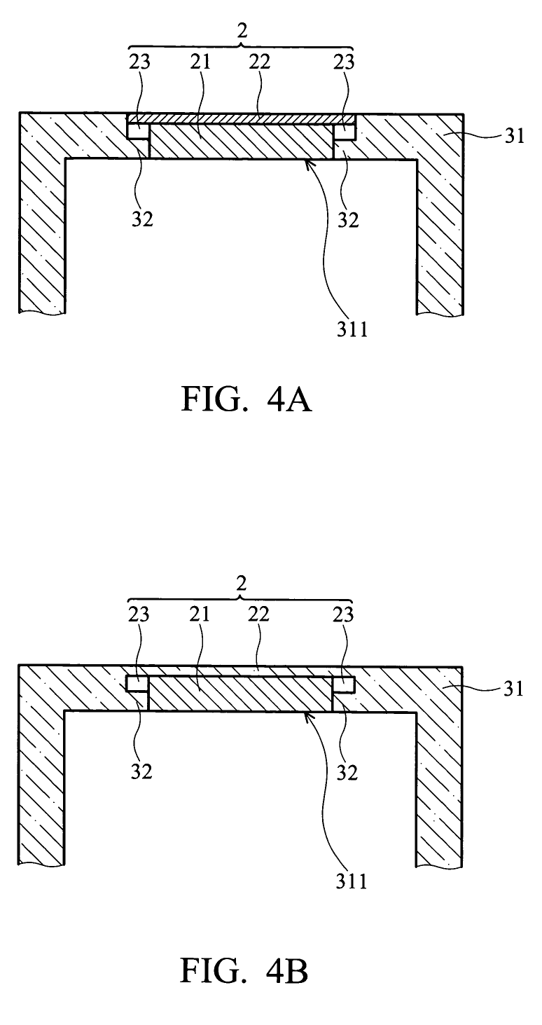

FIG. 4A shows an electronic device of a first embodiment of the invention. The electronic device 3 comprises a housing 31 comprising an opening 311 formed thereon and a touchpad module 2. A body 21 of the touchpad module 2 is disposed in the opening 311. A light permeable element 22 of the touchpad module 2 is disposed near the body 21. A support structure 32 inside the housing 32 supports a light source 23 of the touchpad module 2. Light from the light source 23 passes through the light permeable element 22 and the opening 311 so that the area of the housing 31 where the touchpad module 2 is mounted can emit light. The support structure 32 may comprise a plurality of recesses 321 as shown in FIG. 3, receiving the light source 23.

### Second Embodiment

An electronic device of a second embodiment of the invention is described as following, with similarities to the first embodiment omitted. The main difference from the first embodiment is that the light permeable element 22 and the housing 31 of the electronic device 3 are integrally formed. The body 21 of the touchpad module 2 is disposed adjacent to the light permeable element 22. The light source 23 is disposed under the light permeable element 22 and adjacent to the body 21. The support structure 32 formed in the housing 31 supports the light source 23. Light from the light source 23 passes through the light permeable element 22 so that the area of the housing 31 where the touchpad module 2 is mounted can emit light.

Embodiments of the invention have the following advantages. The structure of the electronic device is simple, and the touchpad module emits light without requiring an expansive self-illuminating touchpad module. In the first embodiment, the light permeable element may be a colored sheet modified according to requirements, thus the profile electronic device is adaptable. In the second embodiment, the light permeable element and the housing are integrally formed, providing the entire electronic device with an aesthetic appearance.

While the invention has been described by way of example and in terms of preferred embodiments, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A touchpad module, comprising:
a body comprising a surface;
a light permeable element disposed adjacent to the surface; and
a light source disposed near the body, emitting a light passing through the light permeable element.

2. The touchpad module as claimed in claim 1, wherein the light source is a light emitting diode (LED).

3. The touchpad module as claimed in claim 1, wherein the light permeable element is made of translucent material or transparent material.

4. The touchpad module as claimed in claim 1, wherein the light permeable element is Polycarbonate (PC).

5. The touchpad module as claimed in claim 1, wherein the light permeable element is Mylar.

6. The touchpad module as claimed in claim 1, wherein the light permeable element has a pattern formed thereon.

7. An electronic device, comprising:
a housing; and
a touchpad module disposed in the housing, comprising:
a body comprising a surface;
a light permeable element disposed adjacent to the surface; and
a light source disposed adjacent to the body, emitting a light passing through the light permeable element.

8. The electronic device as claimed in claim 7, wherein the housing comprises an opening, the light permeable element is disposed adjacent to the opening, and the light from the light source passes through the light permeable element and the opening.

9. The electronic device as claimed in claim 7, wherein the light permeable element and the housing are integrally formed.

10. The electronic device as claimed in claim 7, further comprising a support structure supporting the light source in the housing.

11. The electronic device as claimed in claim 7, the light source is a light emitting diode (LED).

12. The electronic device as claimed in claim 7, wherein the light permeable element is a translucent or a transparent material.

13. The electronic device as claimed in claim 7, wherein the light permeable element is Polycarbonate (PC).

14. The electronic device as claimed in claim 7, wherein the light permeable element is Mylar.

15. The electronic device as claimed in claim 7, wherein the light permeable element has a pattern formed thereon.

16. The electronic device as claimed in claim 7, wherein the electronic device is a notebook computer.

17. The electronic device as claimed in claim 7, wherein the electronic device is a personal digital assistant (PDA).

18. The electronic device as claimed in claim 7, wherein the electronic device is a portable communication device.
